(19) United States
(12) Patent Application Publication
(10) Pub. No.: US 2019/0392744 A1
(43) Pub. Date: Dec. 26, 2019

(54) SIGNAL PROCESSING METHOD, TIMING CONTROL CIRCUIT AND SYSTEM

(71) Applicants: HEFEI XINSHENG OPTOELECTRONICS TECHNOLOGY CO., LTD., HEFEI, ANHUI (CN); BOE TECHNOLOGY GROUP CO., LTD., BEIJING (CN)

(72) Inventors: Jianjun WANG, Beijing (CN); Min WANG, Beijing (CN); Hui DONG, Beijing (CN)

(21) Appl. No.: 16/334,246

(22) PCT Filed: Aug. 31, 2018
(86) PCT No.: PCT/CN2018/103546

§ 371 Date: Mar. 18, 2019

(30) Foreign Application Priority Data
Sep. 5, 2017 (CN) 201710792588.2

(51) Int. Cl. G09G 3/20

(52) U.S. Cl. CPC G09G 3/20; G09G 2310/0243; G09G 2310/08

(57) ABSTRACT

The embodiments of the present disclosure discloses a signal processing method, a timing control circuit, and a system. The signal processing method comprises: receiving a data enable signal or monitoring an estimated data enable signal; and controlling an activate timing of a mask signal according to the data enable signal or the estimated data enable signal. According to the embodiments of the present disclosure, frame-to-frame overlap can be eliminated, thereby solving display anomalies due to undesired overlapping of signals, and also enabling sufficient noise reduction for GOA units under normal input condition, thereby extending the life expectancy of systems such as displays.

### CROSS-REFERENCE TO RELATED APPLICATIONS

The present application claims priority to Chinese Patent Application No. 201710792588.2 filed on Sep. 5, 2017, which is incorporated in its entirety herein by reference.

### FIELD

The present disclosure relates to signal processing techniques and, more particularly, to signal processing methods, timing control circuits, and systems.

### BACKGROUND

The gate driving circuits of the modem display panels generally adopt a Gate Driver on Array (GOA) structure and a Chip On Flex (COF) structure. With the high requirements of ultra-narrow bezels and low cost in modem display products, the GOA structure has become a mainstream product in current displays. Compared with the COF structure, requirements on the electrical parameters of the GOA units in the GOA structure are relatively high, particularly the timings are required to be extremely precise. And in each frame, the timing controller (Timer Control Register, referred to as: TCON) is required to provide a certain number of dummy clock signals (Dummy CLKs) to the GOA unit for performing a noise reduction process on the output of the GOA unit. When the input from the front end is abnormal (such as, continuous times of abnormal power-on or mode changes take place), there may be a situation where the number of dummy clock signals is sufficient, and even the dummy clock signals may not appear (in this case, the count value of the data enable signal for TCON appears to be relatively small). In such a case, this may cause an overlap between the timing signal for a frame and the time signal for a next frame output by the TCON, thereby causing the display to render an abnormal display (AD).

Thus, there is a need in the art for improved signal processing methods, timing control circuits, and systems.

### SUMMARY

Embodiments of the present disclosure provide a signal processing method and a timing control circuit. Embodiments of the present disclosure also provide a system employing the signal processing method or comprising the timing control circuit.

According to an aspect of the present disclosure, a signal processing method is provided that comprises: receiving a data enable signal or monitoring an estimated data enable signal; and controlling an activate timing of a mask signal according to the data enable signal or the estimated data enable signal.

In some embodiments, the signal processing method further comprises: performing counting on basis of that the data enable signal is received. The controlling the activate timing of the mask signal according to the data enable signal may comprise: when the data enable signal is interrupted, controlling the activate timing of the mask signal according to a count value when the data enable signal is interrupted.

In some embodiments, the controlling the activate timing of the mask signal according to the count value comprises: determining whether the count value is greater than or equal to a first threshold; and if yes, activating the mask signal according to a preset activate timing.

In some embodiments, the controlling the activate timing of the mask signal according to the count value comprises: in the case where it is determined that the count value is less than the first threshold and greater than or equal to a second threshold, activating the mask signal before a data enable signal or a frame indication signal for a next frame arrives.

In some embodiments, the controlling the activate timing of the mask signal according to the count value further comprises: determining whether the count value is greater than or equal to a second threshold before determining whether the count value is greater than or equal to the first threshold; and if yes, performing the step of determining whether the count value is greater than or equal to the first threshold.

In some embodiments, the controlling the activate timing of the mask signal according to the count value further comprises: activating the mask signal in the case that it is determined that the count value is less than the second threshold.

In some embodiments, controlling the activate timing of the mask signal according to the estimated data enable signal comprises: activating the mask signal when the estimated data enable signal is asserted.

In some embodiments, said counting comprises one of: counting on basis of a clock signal; counting the data enable signal or the frame indication signal; or counting a length of a pitch of the frame indication signal, the method further comprises: activating the mask signal when the estimated data enable signal is asserted.

In some embodiments, the first threshold is set to be a sum of a number of lines of a frame and a preset number of reset clocks.

In some embodiments, the second threshold is set to be a number of lines of gate lines of a display panel or a number of lines of a frame of a display signal.

According to another aspect of the present disclosure, a timing control circuit is provided that comprises: a receiving-monitoring module configured to receive a data enable signal or monitor an estimated data enable signal; and a control module configured to control an activate timing of a mask signal according to the data enable signal or according to the estimated data enable signal.

In some embodiments, the timing control circuit further comprises: a counter module configured to perform counting according to the data enable signal received by the receiving-monitoring module, wherein the control module is configured to: when the data enable signal is interrupted, control the active time of the mask signal according to a count value of the counter when the data enable signal is interrupted.

In some embodiments, the control module is further configured to: perform counting on basis of that the data enable signal is received by the receiving-monitoring module; and when the data enable signal is interrupted, control the activate timing of the mask signal according to a count value when the data enable signal is interrupted.

In some embodiments, the control module is further configured to: determine, when the data enable signal is interrupted, whether the count value is greater than or equal to a first threshold; and if yes, activate the mask signal according to a preset active timing.

In some embodiments, the control module is further configured to: in the case where it is determined that the count value is less than the first threshold and greater than or equal to the second threshold, activate the mask signal before a data enable signal or a frame indication signal for a next frame arrives.

In some embodiments, the control module is further configured to: determine whether the count value is greater than or equal to a second threshold; and if yes, perform the step of determining whether the count value is greater than or equal to the first threshold.

In some embodiments, the control module is further configured to: activate the mask signal in the case that it is determined that the count value is less than the second threshold.

In some embodiments, the control module is further configured to: activate the mask signal when the estimated data enable signal is asserted.

In some embodiments, the counting comprises one of: counting on basis of a clock signal; counting the data enable signal or the frame indication signal; or counting a length of a pitch of the frame indication signal.

In some embodiments, the first threshold is set to be a sum of a second threshold and a preset number of reset clocks, the second threshold being set to be a number of lines of gate lines of a display panel or a number of lines of a frame of a display signal.

According to a further aspect of the present disclosure, a timing control circuit is provided that comprises: a memory for storing executable instructions; a processor, the executable instructions being adapted to be executed by the processor to implement the signal processing method of any one of the embodiments.

According to a still further aspect of the present disclosure, a system is provided that comprises a timing control circuit according to any of the embodiments.

According to an embodiment of the present disclosure, the activate timing of the mask signal is controlled according to a data enable signal which is received or a estimated data enable signal which is monitored, thereby eliminating the overlap between frames. According to an embodiment of the present disclosure, the activate timing of the mask signal can be dynamically adjusted, thereby solving the abnormal display due to the overlap of the output signal. Also, sufficient noise reduction for the GOA units under normal input conditions can be ensured. Thereby, the life of the timing control circuit and the system (such as but not limited to, a display device or the like) can be improved, and the processing on the abnormal display can also be improved.

In some embodiments, the mask signal is activated when a count value is less than a predetermined threshold. Thereby, the overlap phenomena such as the overlap of TSV signal for the next frame and the clock signal for the current frame can be avoided.

In some embodiments, when the count value is greater than or equal to the preset threshold, counting is continued, and the activate timing of the mask signal can be controlled according to whether the count value satisfies another threshold.

In some examples, the predetermined threshold may be the number of lines included in a frame of a video signal. In some embodiments, the another threshold (also referred to as a first threshold) may be set to be a sum of the preset threshold (also referred to as a second threshold) and preset reset clock(s). When the count value is greater than or equal to the first threshold (which indicates that input from the front end is normal), the mask signal can be activated according to a preset activate timing. On the other hand, when the count value of the line information is less than the first threshold (for example, the sum of the number of lines in the frame and the preset reset clock(s)), this indicates that the front end input is abnormal, at this time, the count value is small, and overlap may occur; at this time, the mask signal is activated to avoid overlap in the timing signal output from the TCON between the frames. In some embodiments, the mask signal may be activated for a certain period of time before the data enable signal for the next frame arrives, so that the overlap the of the timing signal output from the TCON between frames can be sufficiently avoided.

In some embodiments, upon detecting an estimated data enable signal (e.g., the estimated data enable signal is asserted), the mask signal is activated to avoid overlap of timing signals between frames, and to ensure sufficient noise reduction process for the GOA unit in the case that the input is normal.

Other features and advantages of the present disclosure will be set forth in the descriptions as below, and will be obvious partly from the descriptions or can be appreciated by implementing the present disclosure. The objectives and other advantages of the present disclosure can be realized and obtained by the structures specifically described or illustrated in the specification, the appended claims, or the drawings.

### BRIEF DESCRIPTION OF DRAWINGS

The drawings which constitute a part of the specification are used to provide further understandings of the technical solutions of the present disclosure, and together with the embodiments of the present application to explain the technical solutions of the present disclosure, and are not intended to limit the technical solutions of the present disclosure.

FIG. 1 is a schematic diagram showing a signal overlap phenomenon in the related art;

FIG. 2 shows a flow chart of a signal processing method according to some embodiments of the present disclosure;

FIG. 3 shows a flow chart of a signal processing method according to some embodiments of the present disclosure;

FIG. 4 shows a flow chart of a signal processing method according to some embodiments of the present disclosure;

FIG. 5 shows a schematic block diagram of a timing control circuit according to some embodiments of the present disclosure;

FIG. 6 shows a schematic block diagram of a timing control circuit of further embodiments of the present disclosure;

FIG. 7 shows a schematic block diagram of a system in accordance with some embodiments of the present disclosure;

FIG. 8 illustrates processes in steps in accordance with another embodiment.

### DETAILED DESCRIPTION OF ILLUSTRATIVE EMBODIMENTS

Embodiments of the present disclosure will be described in detail below with reference to the accompanying drawings. It should be noted that the embodiments in the present application and the features in the embodiments may be arbitrarily combined with each other unless the context of the description or the principle indicates otherwise expressly or implicitly.

The steps illustrated in the flow charts of the drawings may be executed in, for example, a computer system comprising a set of computer executable instructions. However, the present disclosure is not limited thereto, and for example, the steps shown in the flowchart of the drawings may be implemented by a hardware system (for example, a circuitry system or the like). In addition, although the steps may be shown in some an exemplary order in some flowcharts, the illustrated or described steps may be performed in an order different than that shown in the figures. In some embodiments, some certain steps may be combined into one step or a step may be divided into and performed in several steps.

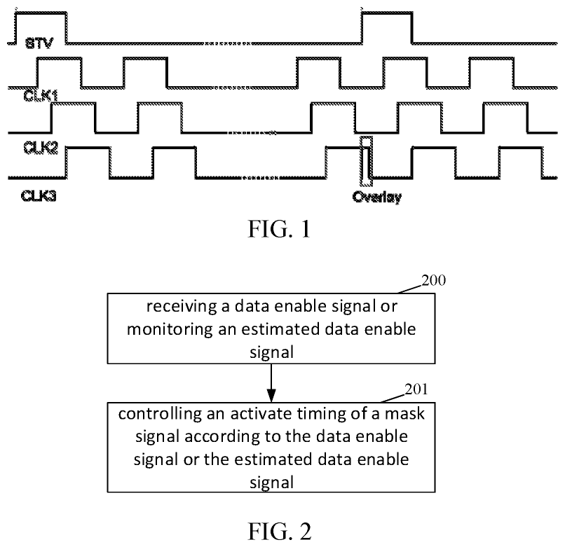

FIG. 1 is a view showing a signal overlap phenomenon in the related art. The inventors of the present application have recognized that, as shown in FIG. 1, when the count value of the data enable signal output by TCON is less than a sum of the number of lines of a signal frame or the number of lines of gate lines driven by the GOA (for example, for FHD, one frame may include 1080 lines) and a predetermined number of dummy clock signals (which indicates that the count value may be too small), the clock signal CLK3 output from the TCON overlaps the frame start (also referred to as StartVertical (STV) in the industry), that is, there is an overlap between frames, resulting in abnormal display of the display.

In view of the above problem, the activate timing of the mask signal output from the TCON is moved to the dummy clock signal area, thereby at the cost of losing the dummy clock signal (the count of the output data enable signal is less than the expected value at this time), the mask signal is forced to be activated in advance, to ensure that the TCON can active the mask signal in advance to clear the overlap of the output timing signal between the frames. However, such a method may cause a problem that the dummy clock signals are output insufficiently when the input from the front end is normal. Moreover, dealing the overlap in this way for a long time may cause insufficient noise reduction for the GOA units, reducing the life of the GOA and the display.

In summary, in the method of processing abnormal input of the GOA in the related art, the dummy clock signal is insufficiently provided when the input of the front end is normal, and when the overlap is processed by the method for a long time insufficient noise reduction may occur for the GOA unit, reducing the service life of the GOA and the display. Obviously, it is difficult in the related art to satisfy both the requirements on processing of abnormal display of the display and the service life of the display.

Here, it should be noted that generally the start of a frame can be indicated by a frame indication signal. Typically a frame start (STV) signal is used to indicate the beginning of a frame. Generally, a Data Enable (DE) signal is used to enable data writing. As an illustrative example, a GOA may be coupled to a gate of a pixel drive transistor to drive (e.g., turn on or off) the pixel drive transistor. A data signal may be loaded to a pole of the pixel drive transistor such that, for example, a light emitting element may be droved according to the data.

Generally, for the line scan display manner, in order to scan each line of the frame, a data enable signal is provided for each line of the frame (in other words, the data enable signal corresponding to the line is asserted).

The assertion or provision of the data enable signal can be made based on the corresponding clock. The frequency of the data enable signal can be consistent with the frequency of the line scan. The frequency of the data enable signal may be consistent with, or may be several multiples of, the frequency of the corresponding clock (such as, but not limited to, a reference clock). Generally, a dummy clock signal can be considered as a clock signal provided for a dummy line, and the configuration of the dummy clock signal can be identical to that of the clock signal used for a real line.

Referring to FIG. 2, a signal processing method in accordance with some embodiments of the present disclosure is illustrated. The method comprises: step 200 of receiving a data enable signal or monitoring an estimated data enable signal. The method further comprises: step 201 of controlling an activate timing of a mask signal according to the data enable signal or the estimated data enable signal.

Optionally, in some embodiments, the method further comprises: performing counting based on receiving of the data enable signal. In some implementations, the counting may comprise counting one or both of the following: a Date Enable (DE) signal and/or a frame indication signal. However, the present disclosure is not limited thereto. For example, when a data enable signal or a frame indication signal is received, counting can be performed based on a clock signal. As another example, counting can be performed on a duration of, or a length of the pitch of, the frame indication signal, such as, a frame start (STV) signal. For example, it is possible to perform counting, when a frame start (STV) signal is received, based on a clock signal. In such a way, a count value of the counting when the data enable signal is interrupted can be determined. The count value can indicate the time (or number of clock cycles) elapsed before the input (e.g., DE signal) is interrupted. For example, it is possible to determine the length of time elapsed from the time when the DE signal or the STV signal for a frame of a video signal is received to the time when the data enable signal is interrupted.

Here, the frame indication signal may be the STV signal.

In some embodiments, controlling the activate timing of the mask signal according to the data enable signal comprises:

when the data enable signal is interrupted, controlling the activate timing of the mask signal according to the count value when the data enable signal is interrupted.

In some embodiments, controlling the activate timing of the mask signal according to the count value comprises:

determining whether the count value of the data enable signal is greater than or equal to a first threshold, and if yes, activate the mask signal according to a preset activate timing. As an example, the first threshold may be set to a sum of a preset threshold and preset reset clock(s).

In some examples, the preset threshold may be set to be the number of lines of gate lines of a display panel or the number of lines of a frame.

Optionally, in the case where it is determined that the count value is less than the first threshold and greater than a second threshold, the mask signal is activated before a data enable signal or a frame indication signal for a next frame arrives. The second threshold may be set to be the number of gate lines of the display panel or the number of lines of a frame.

Optionally, before determining whether the count value is greater than or equal to the first threshold, it can be determined whether the count value is greater than or equal to the second threshold. If yes, it proceed to conduct the step of determining whether the count value is greater than or equal to the first threshold.

Optionally, when it is determined that the count value of the data enable signal is less than a preset second threshold, the mask signal is activated.

In some embodiments, the preset threshold or the preset second threshold may be the number of gate lines of the display panel or the number of lines of frames of a display signal (e.g., a video signal to be displayed).

When the count value is less than the second threshold, it indicates that the displaying of the frame has not been completed when an abnormality occurs. For example, when the count value for the data enable signal is less than the preset threshold, it indicates that the lines of the frame are not completely scanned, because the timing signal of the TCON is output according to at least the number of gate lines of the display panel or as a function of the frame to be displayed. Therefore, if the count value is less than the second threshold, the current frame may possibly not be fully displayed, and the next frame arrives in advance, thereby causing overlap of the timing signals output from the TCON so that the data of the next frame is provided when the current frame is not fully displayed. To this, according to an embodiment of the present disclosure, a mask signal is activated in such a case, thus the occurrence of signal overlap can be avoided.

In some embodiments, the method further comprises: upon the estimated data enable signal is asserted, activating the mask signal regardless of the count value.

In other embodiments, controlling the activate timing of the mask signal based on the estimated data enable signal comprises: activating the mask signal when the estimated data enable signal is asserted. That is, the mask signal is activated when a valid estimated data enable signal is detected.

In some embodiments, the estimated data enable signal can be provided at a predetermined location (timing) prior to the data enable signal for the data of each frame.

According to the embodiments of the present disclosure, the activate timing of the mask signal is controlled according to the received data enable signal or the monitored estimated data enable signal, thereby eliminating the overlap between frames. By dynamically adjusting the activate timing of the mask signal, the display abnormality due to overlap phenomenon of the output signal can be solved, and the GOA unit can be sufficiently noise-reduced under the condition of normal input, thereby satisfying the requirement on the service life of the display.

In some embodiments of the present disclosure, when a count value for a data enable signal or the like is less than a preset second threshold, the mask signal is activated, avoiding the occurrence of the overlap phenomenon.

In some embodiments, when the count value is greater than or equal to the first threshold (in some examples, the first threshold is set to be the sum of the aforementioned preset second threshold and the preset reset clock(s)) (this indicates that the front end input is normal), the mask signal can be activated according to a preset activate timing. When the count value is less than the first threshold (for example, the sum of the number of lines and the number of the preset reset clock(s)), the number of the reset clocks may be not sufficient to conduct a sufficient noise-reduce process for the GOA unit, which may damage the GOA unit and affect the life of the display if it continues for a long time.

According to some embodiments of the present disclosure, when the estimated data enable signal is asserted (valid), the mask signal is activated, which avoids the overlap between the frames, ensures sufficient noise reduction process for the GOA unit, and increases the life of display devices and systems.

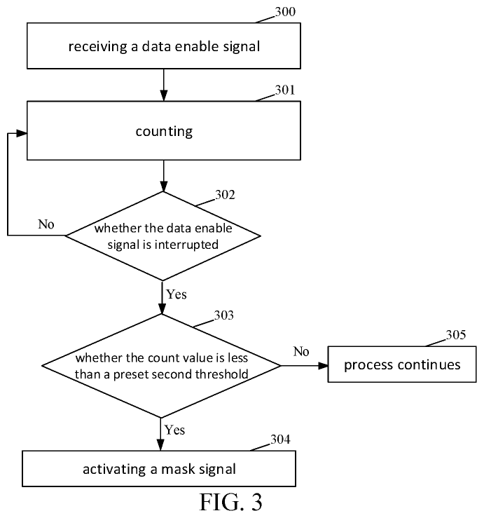

Referring to FIG. 3, a signal processing method according to some embodiments of the present disclosure is proposed that comprises the following steps.

Step 300: receiving a data enable signal. For example, in some embodiments, a data enable signal is provided while a frame indication signal, such as an STV signal, is provided.

Step 301, performing counting. For example but not limited to, counting is performed on the data enable signal.

Step 302: determining whether the data enable signal is interrupted. If yes, it proceeds to step 303; if not, proceeds to step 301.

Step 303: determining whether the count value is less than a preset second threshold. If yes, it proceeds to execute step 304 and end the process; if not, it proceeds to step 305.

Step 304: activating a mask signal.

Step 305: process continues to next move. For example, process can be continued in accordance with the embodiments to be described below.

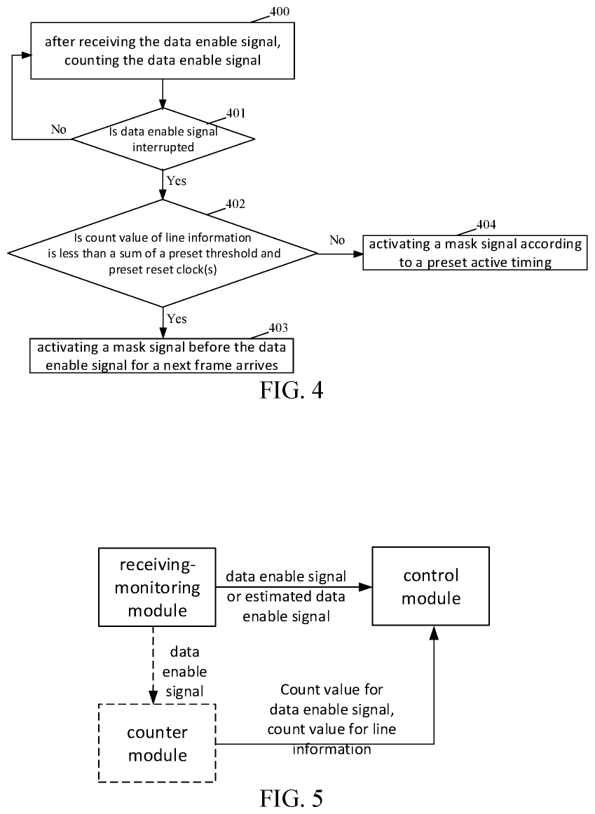

A process as above-mentioned in connection with step 305 will be described below with reference to FIG. 4. As shown in FIG. 4, the process according to an embodiment may comprise the following steps.

Step 400: after receiving the data enable signal, counting the data enable signal.

Step 401: determining whether the data enable signal is interrupted. If yes, it proceeds to step 402; if not, proceeds to step 400.

Step 402: determining whether the count value of the data enable signal is less than a sum of a preset threshold and preset reset clock(s). If yes, it proceeds to execute step 403 and end the process; if not, execute step 404.

Step 403: activating a mask signal before the data enable signal for a next frame arrives.

Step 404: activating a mask signal according to a preset active timing.

Since the data for the next frame is known, it is easy to know when the next frame data should arrive. The mask signal can be configured to eliminate the undesirable overlap of the signal for the next frame and signal for the current frame.

A process in connection with step 305 according to another embodiment is explained below with reference to FIG. 8. As shown in FIG. 8, the process may comprise the following steps.

Step 802: determining that the count value is greater than or equal to the first threshold. It is to be noted that step 802 is performed in the case where it is determined in step 303 as shown in FIG. 3 that the count value is not less than the preset second threshold (that is, the count value is greater than or equal to the preset second threshold).

If yes, it proceeds to step 803 If not, it proceeds to step 804.

Step 803: activating the mask signal according to a preset activate timing.

Step 804: activating the mask signal before a data enable signal or a frame indication signal for a next frame arrives.

Referring now to FIG. 5, a timing control circuit of an embodiment of the present disclosure is illustrated. As shown in FIG. 5, the timing control circuit comprises: a receiving-monitoring module configured to receive a data enable signal or monitoring a data enable signal; and a control module configured to control an activate timing of a mask signal according to the data enable signal or an estimated data enable signal.

In some embodiments, optionally, the timing control circuit may further comprise: a counter module configured to perform counting based on the data enable signal is received by the receiving-monitoring module.

In some embodiments, the control module is further configured to: control, when the data enable signal is interrupted, the activate timing of the mask signal according to the count value when the data enable signal is interrupted.

In some embodiments, the control module is further configured to: count based on the receiving-monitoring module receiving the data enable signal; and when the data enable signal is interrupted, control the activate timing of the mask signal according to the count value when the data enable signal is interrupted.

In some embodiments, optionally, the control module is further configured to: determine, when the data enable signal is interrupted, whether the count value is greater than or equal to a first threshold, and if yes, activating the mask signal according to a preset activate timing.

In some embodiments, optionally, the control module is further configured to: when it is determined that the count value is less than the first threshold, activate the mask signal before the data enable signal for or a frame indication signal for the next frame arrives.

In some embodiments, optionally, the control module is further configured to: determine whether the count value is greater than or equal to a second threshold, and if yes, continue to perform the step of determining whether the count value is greater than or equal to the first threshold.

In some embodiments, optionally, the control module is further configured to: activate the mask signal if it is determined that the count value is less than the second threshold.

In some embodiments, optionally, the control module is further configured to: activate the mask signal when the estimated data enable signal is asserted.

In some embodiments, as described above, the counting comprises one of: counting based on a clock signal; counting the data enable signal or the frame indication signal; or counting a time length of a pitch of the frame indication signal.

In some embodiments, the first threshold may be set to a sum of a second threshold and a preset number of reset clock(s), and the second threshold may be set to a number of gate lines of a display panel or a line of a number of lines of a frame of a display signal.

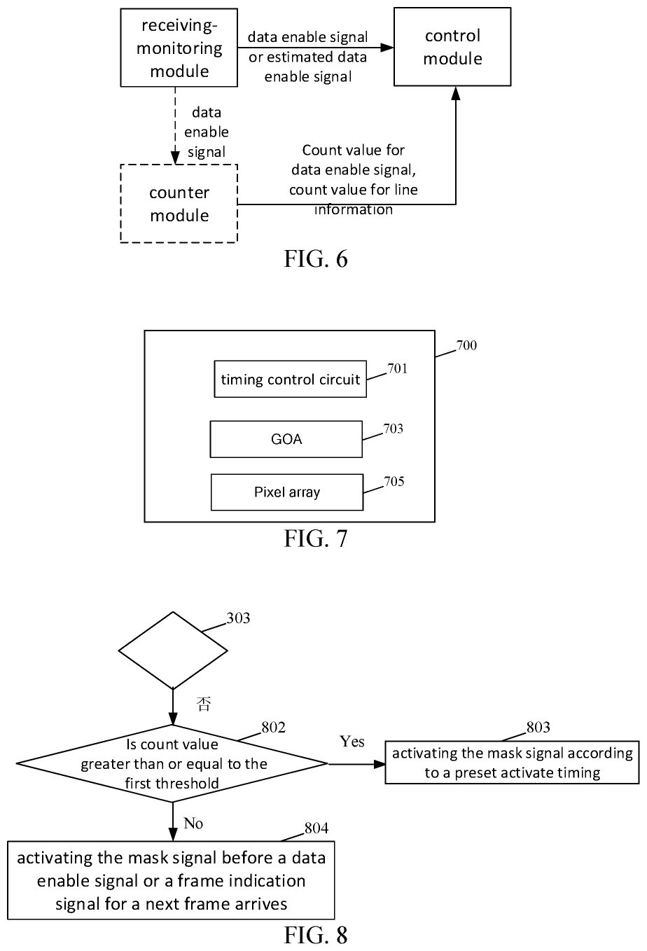

Referring to FIG. 6, according to some embodiments of the present disclosure, a timing control circuit is provided that comprises: a memory and a processor. The memory can be used to store executable instructions. The processor can be operative to execute the executable instructions stored in the memory to implement the signal processing methods described in any of the above embodiments.

Also, according to embodiments of the present disclosure, a computer readable storage medium is provided that stores computer executable instructions that, when executed by a processor, can implement the signal process method described in any of the above embodiments.

According to embodiments of the present disclosure, a system (such as but not limited to, a display system) is provided that may comprise a timing control circuit in accordance with any of the embodiments. As shown in FIG. 7, system 700 can comprise a timing control circuit 701 in accordance with any of the embodiments. System 700 can also comprise, for example, a GOA circuit and/or a pixel array or the like. Those skilled in the art will readily appreciate that the system can be implemented as any system including a display device such as, but not limited to, a display, a head mounted or wearable device, a cell phone, a computer, a video game console, or the like.

As above, the embodiments of the present disclosure are described, but the contents disclosed here are merely embodiments for facilitating the understanding of the present disclosure, and are not intended to limit the present disclosure. Various modification or variation in the forms and details of the embodiments can be made by those skilled in the art without departing from the spirit and scope of the present disclosure. The scope of the present disclosure shall be defined by the appended claims only.

The present application claims priority to Chinese Patent Application No. 201710792588.2 filed on Sep. 5, 2017, which is incorporated in its entirety herein by reference.

1. A signal processing method comprising:
performing at least one of receiving a data enable signal or monitoring an estimated data enable signal; and
controlling an activate timing of a mask signal according to at least one of the data enable signal or the estimated data enable signal.

2. The signal processing method according to claim 1, further comprising:
performing counting on basis of that the data enable signal is received,
wherein the controlling the activate timing of the mask signal according to the data enable signal comprises:
controlling, responsive to an interruption of the data enable signal, the activate timing of the mask signal according to a count value when the data enable signal is interrupted.

3. The signal processing method according to claim 2, wherein the controlling the activate timing of the mask signal according to the count value comprises:
determining that the count value is greater than or equal to a first threshold; and
activating, responsive to the determination that the count value is greater than or equal to a first threshold, the mask signal according to a preset activate timing.

4. The signal processing method according to claim 3, wherein the controlling the activate timing of the mask signal according to the count value comprises:
activating, based on a determination that the count value is less than the first threshold and greater than or equal to a second threshold, the mask signal before a data enable signal or a frame indication signal for a next frame arrives.

5. The signal processing method according to claim 3, wherein the controlling the activate timing of the mask signal according to the count value further comprises:
determining that the count value is greater than or equal to a second threshold; and
determining, subsequent to the determination that the count value is greater than or equal to a second threshold, whether the count value is greater than or equal to the first threshold.

6. The signal processing method according to claim 5, wherein the controlling the activate timing of the mask signal according to the count value further comprises:
activating the mask signal responsive to a determination that the count value is less than the second threshold.

7. The signal processing method according to claim 1, wherein
controlling the activate timing of the mask signal according to the estimated data enable signal comprises:
activating the mask signal responsive to an assertion of the estimated data enable signal.

8. The signal processing method according to claim 2, wherein said counting comprises one of:
counting on basis of a clock signal;
counting the data enable signal or the frame indication signal; or
counting a length of a pitch of the frame indication signal,
the method further comprises:
activating the mask signal responsive to an assertion of the estimated data enable signal.

9. The signal processing method according to claim 3, wherein the first threshold is set to be a sum of a number of lines of a frame and a preset number of reset clocks.

10. The signal processing method according to claim 5, wherein the second threshold is set to be a number of lines of gate lines of a display panel or a number of lines of a frame of a display signal.

11. A timing control circuit comprising:
a receiving-monitoring module configured to perform at least one of receive a data enable signal or monitor an estimated data enable signal; and
a control module configured to control an activate timing of a mask signal according to at least one of the data enable signal or the estimated data enable signal.

12. The timing control circuit of claim 11 further comprising:
a counter module configured to perform counting according to the data enable signal received by the receiving-monitoring module,
wherein the control module is configured to:
control, responsive to an interruption of the data enable signal, the active time of the mask signal according to a count value of the counter when the data enable signal is interrupted.

13. The timing control circuit of claim 11, wherein the control module is further configured to:
perform counting on basis of that the data enable signal is received by the receiving-monitoring module; and
control, responsive to an interruption of the data enable signal, the activate timing of the mask signal according to a count value when the data enable signal is interrupted.

14. The timing control circuit of claim 12, wherein the control module is further configured to:
determine, when the data enable signal is interrupted, that the count value is greater than or equal to a first threshold; and
activate, responsive to the determination that the count value is greater than or equal to the first threshold, the mask signal according to a preset active timing.

15. The timing control circuit of claim 14, wherein the control module is further configured to:
responsive to a determination that the count value is less than the first threshold and greater than or equal to the second threshold, activate the mask signal before at least one of a data enable signal or a frame indication signal for a next frame arrives.

16. The timing control circuit of claim 12, wherein the control module is further configured to:
determine that the count value is greater than or equal to a second threshold; and
determine, responsive to the determination that the count value is greater than or equal to the second threshold, whether the count value is greater than or equal to the first threshold.

17. The timing control circuit of claim 16, wherein the control module is further configured to:
Activate, responsive to a determination that the count value is less than the second threshold, the mask signal.

18. The timing control circuit of claim 11, wherein the control module is further configured to:
activate the mask signal responsive to an assertion of the estimated data enable signal.

19. The timing control circuit according to claim 12,
wherein the counting comprises one of:
counting on basis of a clock signal;
counting the data enable signal or the frame indication signal; or
counting a length of a pitch of the frame indication signal.

20. The timing control circuit according to claim 14, wherein the first threshold is set to be a sum of a second threshold and a preset number of reset clocks, the second threshold being set to be at least one of a number of lines of gate lines of a display panel or a number of lines of a frame of a display signal.

21. (canceled)

22. (canceled)
